(19) United States
(12) Patent Application Publication
(10) Pub. No.: US 2025/0368142 A1
(43) Pub. Date: Dec. 4, 2025

(54) VEHICLE-MOUNTED EYEGLASSES HOLDER

(71) Applicant: SHENZHEN GLAMORTECH INDUSTRIAL CO., LTD, Shenzhen (CN)

(72) Inventor: Pengbo MU, Shenzhen (CN)

(21) Appl. No.: 18/923,714

(22) Filed: Oct. 23, 2024

(30) Foreign Application Priority Data
Jun. 4, 2024 (CN) 202410713200.5
Jun. 4, 2024 (CN) 202421255865.8

(51) Int. Cl. B60R 7/08

(52) U.S. Cl. CPC B60R 7/082

(57) ABSTRACT

The present application provides a vehicle-mounted eyeglasses holder, comprising a first arm, a second arm, a hinge part, a first elastic cushion and a second elastic cushion, wherein the first arm and the second arm are connected via the hinge part, the first elastic cushion is fixedly connected to the first arm, the second elastic cushion is fixedly connected to the second arm, and the first elastic cushion abuts against the second elastic cushion; the first elastic cushion comprises a solid portion, an extension portion and a tail portion, which enclose to form a cavity; the extension portion and the second elastic cushion form a clamping space, and the extension portion will be squeezed to deform; the solid portion is arranged at an open end of the vehicle-mounted eyeglasses holder, and comprises an outer guide inclined surface for guiding the eyeglasses to slide into the clamping space.

### TECHNICAL FIELD

The present application relates to the technical field of vehicles, in particular to a vehicle-mounted eyeglasses holder.

### BACKGROUND ART

When a driver is exposed to strong light during driving, he/she may wear eyeglasses (e.g., sunglasses) to shield from the strong light. Under normal conditions, it is not recommended for the driver to wear sunglasses. A vehicle-mounted eyeglasses clip may be used to store eyeglasses, and is usually mounted at the position of a vehicle-mounted sun visor. Therefore, obviously there is a demand for users to take eyeglasses out of a vehicle-mounted eyeglasses clip and place the eyeglasses into the vehicle-mounted eyeglasses clip, and it is expected for such actions to be more convenient and labor-saving under the premise of safe driving, for example, the vehicle-mounted eyeglasses clip is disposed at a convenient position and can be manipulated with one hand, the eyeglasses can be taken out of the vehicle-mounted eyeglasses clip and placed into the vehicle-mounted eyeglasses clip more smoothly, the vehicle-mounted eyeglasses clip can be used to clamp eyeglasses of different sizes, without damage to the clamped eyeglasses during use, and can clamp the eyeglasses more stably, etc.

All existing vehicle-mounted eyeglasses clips available in the market are made of solid materials, such as plastic, it is inconvenient to take eyeglasses out of these vehicle-mounted eyeglasses clips and place eyeglasses into these vehicle-mounted eyeglasses clips, and these vehicle-mounted eyeglasses clips have to be manipulated with both hands and are inconvenient to use, and may bring safety risks at the same time; meanwhile, vehicle-mounted eyeglasses clips made of solid materials cannot perfectly adapt to eyeglasses of different sizes, and may result in problems of unstable clamping and damages to eyeglass legs.

### Contents of the Invention

In view of above problems and the defects in the prior art, in the examples of the present application, a vehicle-mounted eyeglasses holder that is convenient to use, safe, durable and labor-saving is provided, so as to solve the problems that existing vehicle-mounted eyeglasses clips are not adaptive to eyeglasses of different sizes, it is difficult to take eyeglasses out of these vehicle-mounted eyeglasses clips and place eyeglasses into these vehicle-mounted eyeglasses clips, and the manipulation of these vehicle-mounted eyeglasses clips is complicated.

To attain the object described above, the present disclosure employs the following technical solution:

A vehicle-mounted eyeglasses holder, comprising a first arm, a second arm, a hinge part, a first elastic cushion and a second elastic cushion, wherein the first arm and the second arm are connected via the hinge part, the first elastic cushion is fixedly connected to the first arm, the second elastic cushion is fixedly connected to the second arm, and the first elastic cushion abuts against the second elastic cushion; the first elastic cushion comprises a solid portion, an extension portion and a tail portion, which enclose to form a cavity; the extension portion and the second elastic cushion form a clamping space at a corresponding position, and when eyeglasses slide into the clamping space, the extension portion will be squeezed to deform; the solid portion is arranged at an open end of the vehicle-mounted eyeglasses holder, and comprises an outer guide inclined surface for guiding the eyeglasses to slide into the clamping space, and the outer guide inclined surface extends to form the extension portion.

Furthermore, the first elastic cushion and the second elastic cushion abut against each other at least at the position of the solid portion.

Furthermore, the first elastic cushion and the second elastic cushion abut against each other at the position of the extension portion.

Furthermore, an inner guide inclined surface is formed at a position where the solid portion is connected with the cavity.

Furthermore, the solid portion is arranged in a generally arch shape by means of the outer guide inclined surface and the inner guide inclined surface.

Furthermore, the extension portion is configured generally as a plane.

Furthermore, the structure of the second elastic cushion and the structure of the first elastic cushion are arranged in mirror.

Furthermore, the first elastic cushion and/or the second elastic cushion are silicone cushions.

Furthermore, the vehicle-mounted eyeglasses holder further comprises a fixing piece, and the first elastic cushion is connected to the first arm via the fixing piece and/or the second elastic cushion is fixedly connected to the second arm via the fixing piece.

Furthermore, the vehicle-mounted eyeglasses holder further comprises a clip, which is fixedly connected to the first arm or the second arm.

The examples of the present disclosure achieve the following beneficial effects:

The present invention relates to a vehicle-mounted eyeglasses holder, which comprises a first elastic cushion and a second elastic cushion that are arranged between a first arm and a second arm and abut against each other, wherein the first elastic cushion comprises a solid portion, an extension portion and a tail portion, which enclose to form a cavity to provide a clamping space when eyeglasses are clamped; since the first elastic cushion and the second elastic cushion abut against each other, the stability for clamping the eyeglasses can be provided. The outer guide inclined surface of the solid portion can make the user slide the eyeglasses into the clamping space more easily, and the extension portion formed by extending of the outer guide inclined surface works together with the solid portion so that the eyeglasses can be taken out more easily.

The first elastic cushion and the second elastic cushion abut against each other at the position of the solid portion, so that a blocking body can be provided when the eyeglasses are clamped, and the blocking body can block the eyeglasses and prevent the eyeglasses from slipping out of the clamping space.

The first elastic cushion and the second elastic cushion abut against each other at the position of the extension portion, thereby a better clamping force can be provided when the eyeglasses are clamped, so that the clamp is more stable.

An inner guide inclined surface is formed at a position where the solid portion is connected with the cavity, and when the eyeglasses slide out to the position of the solid portion during the process of the eyeglasses being take out by the user, the inner guide inclined surface can guide the eyeglasses to slide to the top of the solid portion, so that the eyeglasses can slide out of the clamping space more easily.

The solid portion forms a generally arch shape by means of the outer guide inclined surface and the inner guide inclined surface, so as to provide a guide path when the eyeglasses slide in and out; thus, it is more convenient to place the eyeglasses into the vehicle-mounted eyeglasses holder and take the eyeglasses out of the vehicle-mounted eyeglasses holder, and the eyeglasses can be placed into the vehicle-mounted eyeglasses holder and taken out of the vehicle-mounted eyeglasses holder with one hand.

The extension portion is configured generally as a plane, so as to provide larger clamping area, thereby the eyeglasses can be clamped stably at any position in the clamping space.

The structure of the second elastic cushion and the structure of the first elastic cushion are arranged in mirror, thereby the guide area of the open end is larger, and the eyeglasses can be placed into the vehicle-mounted eyeglasses holder more conveniently; besides, the vehicle-mounted eyeglasses holder has a larger clamping space and can adapt to more articles of different sizes, without being limited to eyeglasses.

The first elastic cushion and/or the second elastic cushion made of a silicone material can protect the eyeglasses from being scratched when the eyeglasses slide in and out, and can provide different rigidities according to different thicknesses of different parts of the cushions to meet the deformation requirement.

The elastic cushions are fixed by means of a fixing piece, so as to provide a more stable connection and ensure the stability of the product.

The vehicle-mounted eyeglasses holder may be mounted on a sun visor by means of the clip.

To make the above objects, features and advantages of the present application more obvious and easier to understand, some preferred examples will be described below in detail with reference to the accompanying drawings.

### BRIEF DESCRIPTION OF DRAWINGS

In order to explain the technical solutions in the examples of the present application more clearly, the accompanying drawings used in the examples will be introduced below briefly. It should be understood that the accompanying drawings described below only illustrate some examples of the present application, and should not be deemed as constituting any limitation to the scope of the present invention. Those having ordinary skills in the art can obtain other related drawings based on these drawings without expending any creative labor.

FIG. 1 shows a schematic structural view of a vehicle-mounted eyeglasses holder provided in an example of the present application;

FIG. 2 shows an exploded structural view of the vehicle-mounted eyeglasses holder in FIG. 1;

FIG. 3 shows a schematic structural view of a first arm provided in an example of the present application;

FIG. 4 shows a schematic structural view of a second arm provided in an example of the present application;

FIG. 5 shows a schematic structural view of a spring provided in an example of the present application;

FIG. 6 shows a schematic structural view of a first elastic cushion provided in an example of the present application;

FIG. 7 shows a sectional structural view of the first elastic cushion in FIG. 6;

FIG. 8 shows a schematic structural view of a clip provided in an example of the present application; and

FIG. 9 show a schematic diagram of the vehicle-mounted eyeglasses holder provided in an example of the present application during use.

### REFERENCE NUMERALS IN FIGURES

1—first arm; 101—clamping hole; 102—first arm fixing hole; 103—first arm pivot hole; 104—first arm clamping slot; 107—protrusion clamping position;
2—second arm; 202—second arm fixing hole; 203—second arm pivot hole; 206—spring clamping slot; 208—second arm clamping slot; 210—second arm mounting hole;
3—hinge part; 31—spring; 311—middle protrusion of spring; 312—spring end; 32—pivot shaft;
4—first elastic cushion; 404—cushion protrusion; 405—fixing piece clamping slot; 422
outer guide inclined surface; 423—solid portion; 424—inner guide inclined surface; 425—cavity; 426—extension portion; 427—tail portion;
5—second elastic cushion;
6—clip; 610—clip fixing hole.

### EMBODIMENTS

To make the object, technical solution, and advantages of the examples of the present application more clear, hereunder the technical solution in the examples of the present application will be detailed clearly and completely, with reference to the accompanying drawings in the examples of the present application. Apparently, the examples described here are only some examples of the present application rather than all examples of the present application.

On that basis, some embodiments of the present application will be described in detail with reference to the accompanying drawings. The following examples and the features in the examples can be combined with each other, provided there is no conflict.

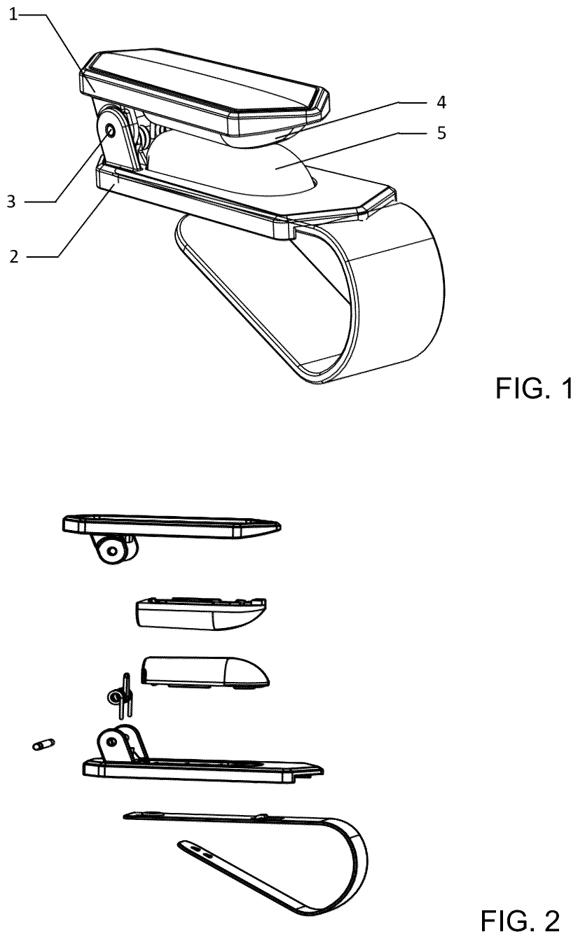

Please refer to FIGS. 1 and 7. A vehicle-mounted eyeglasses holder provided in an example of the present application comprises a first arm 1, a second arm 2, a hinge part 3, a first elastic cushion 4 and a second elastic cushion 5, wherein the first arm 1 and the second arm 2 are connected via the hinge part 3, the first elastic cushion 4 is fixedly connected to the first arm 1, the second elastic cushion 5 is fixedly connected to the second arm 2, and the first elastic cushion 4 comprises a solid portion 423, an extension portion 426 and a tail port 427, which enclose to form a cavity 425; the second elastic cushion 5 and the first elastic cushion 4 are arranged opposite to each other, the extension portion 426 of the first elastic cushion 4 and the second elastic cushion 5 form a clamping space at a corresponding position; when eyeglasses slide into the clamping space along the solid portion, the extension portion 426 can be squeezed to deform and sag toward the cavity. FIG. 9 shows the vehicle-mounted eyeglasses holder provided in the example of the present application during use. The solid portion 423 is arranged at an open end of the vehicle-mounted eyeglasses holder, i.e., the end away from the hinge part 3; the solid portion 423 comprises an outer guide inclined surface 422 for guiding eyeglasses to slide into the clamping space, and the outer guide inclined surface 423 further extends to form the extension portion 426.

It can be understood that the solid portion 423 has better rigidity when compared with the extension portion 426. In some alternative examples, the solid portion 423 and the extension portion 426 are integrally formed and made of the same material, such as silicone. During use, the solid portion 423 is not easy to deform, while the extension portion 426 is easy to deform. For example, when the eyeglasses slide into the clamping space, the extension portion 426 can be deformed easily under a squeezing action of the eyeglass legs, so as to accommodate the eyeglass legs.

In some alternative examples, the first elastic cushion 4 and the second elastic cushion 5 abut against each other at least at the position of the solid portion 423. When the eyeglasses are clamped, the abutting position can prevent the eyeglasses from slipping out of the clamping space. Specifically, since the solid portion 423 has better rigidity than the extension portion 426 and is not easy to deform, when the extension portion 426 has been deformed in the clamping state, the solid portion 423 and the second elastic cushion 5 respectively abutting against the solid portion 423 provide a blocking body that can block the eyeglasses from slipping out.

In some alternative examples, the first elastic cushion 3 and the second elastic cushion 4 abut against each other at the position of the extension portion 426, so as to provide better clamping force when the eyeglasses are clamped, thereby the clamp is more stable.

In some alternative examples, an inner guide inclined surface 424 is formed at a position where the solid portion 423 is connected with the cavity, and when the eyeglasses slide out to the position of the solid portion 423 during the process of the eyeglasses being taken out by the user, the inner guide inclined surface can guide the eyeglasses to slide to the top of the solid portion, so that the eyeglasses can slide out of the clamping space more easily.

It can be understood that the solid portion 423 can be formed into any shape by means of the outer guide inclined surface 422 and the inner guide inclined surface 424. For example, the outer guide inclined surface 422 and the inner guide inclined surface 424 are located at the same side of a vertical line, wherein the vertical line refers to a virtual straight line passing through a virtual intersection between the outer guide inclined surface 422 and the inner guide inclined surface 424 and perpendicular to the plane where the extension portion 426 is located; thus, a guide path can be provided when the eyeglasses slide in and out, thereby the eyeglasses can be placed into and taken out of the vehicle-mounted eyeglasses holder more conveniently, and the operation can be performed with one hand.

Furthermore, in a preferred intersection, the solid portion 423 is formed into a generally arch shape by means of the outer guide inclined surface 422 and the inner guide inclined surface 424, i.e., the outer guide inclined surface 422 and the inner guide inclined surface 424 are located at two sides of the vertical line respectively. Thus, a better guide path can be provided when the eyeglasses slide in and out, the eyeglasses can be placed into the and taken out of the vehicle-mounted eyeglasses holder more conveniently, and the operation can be performed with one hand.

In some alternative intersections, the extension portion 426 is configured generally as a plane, so as to provide larger clamping area, thereby the eyeglasses can be clamped stably at any position in the clamping space.

In some alternative intersections, the second elastic cushion 5 as w whole has a generally planar structure.

Furthermore, in a preferred example, the structure of the second elastic cushion 5 and the structure of the first elastic cushion 4 are arranged in mirror, thereby the guide area of the open end can be larger, the eyeglasses can be placed into the vehicle-mounted eyeglasses holder more conveniently, and the clamping space can be larger, and can adapt to more articles of different sizes, without being limited to eyeglasses.

In some alternative examples, the first elastic cushion 4 and/or the second elastic cushion 5 are made of a silicone material; thus, they can protect the eyeglasses from being scratched when the eyeglasses slide in and out, and can provide different rigidities according to different thicknesses of different parts of the elastic cushions to meet the deformation requirement. It can be understood that the first elastic cushion 4 and/or the second elastic cushion 5 may be made of other materials with an elastic deformation ability, such as rubber, soft plastic, or other macromolecular elastic materials.

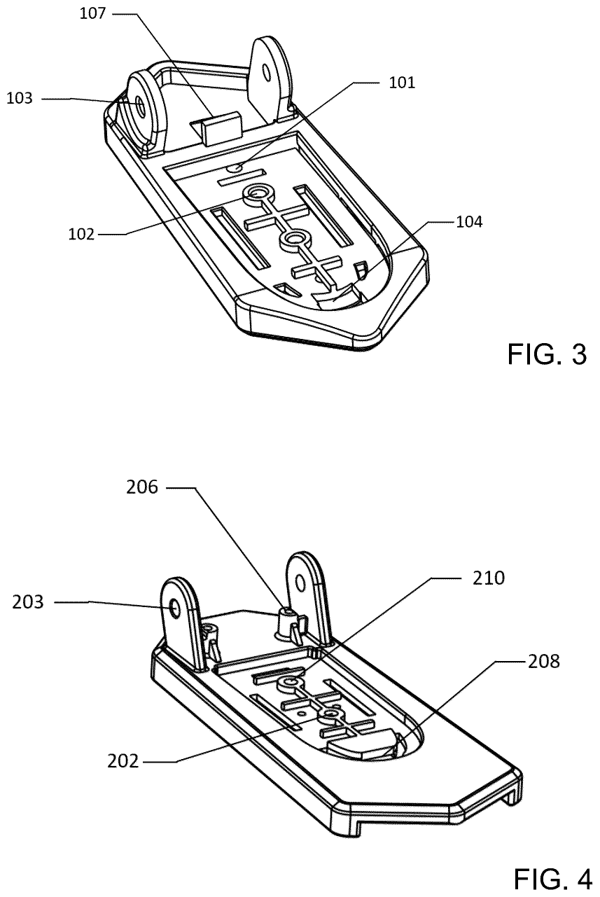

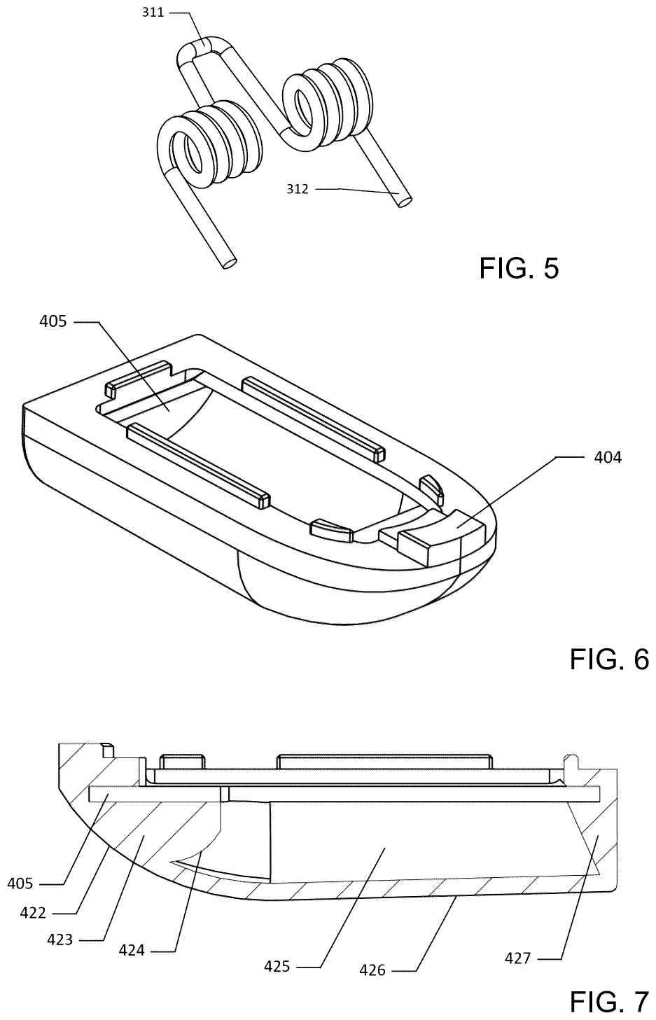

Please see FIGS. 2 to 6. The first arm 1 is provided with a first arm fixing hole 102, and the fixing piece is provided with a through-hole at a corresponding position, so that the fixing piece can be fixedly connected to the first arm by inserting a screw through the first arm fixing hole 102 and the fixing piece through hole at the same time. Similarly, another fixing piece can be fixedly connected to the second arm 2 by inserting a screw through a second arm fixing hole 202 in the second arm 2 and a through-hole in the another fixing piece.

In some alternative examples, the first arm 1 is provided with a clamping hole 101 for fixedly connecting a protective sleeve of the first arm to the first arm 1.

In some alternative examples, the first arm 1 is provided with a first arm clamping slot 104, and the first elastic cushion 3 is provided with a cushion protrusion 404 and a fixing piece clamping slot 405. The fixing piece can be fixedly connected to the first arm 1 by clamping the cushion protrusion 404 into the first arm clamping slot 104 and clamping the fixing piece into the fixing piece clamping slot 405 at the same time. Then, based on the method for fixedly connecting the above fixing piece to the first arm 1, a fixed connection between the first elastic cushion 3 and the first arm 1 is completed. Similarly, the second elastic cushion 5 can be fixedly connected to the second arm 2 in the same way.

In some alternative examples, the first arm 1 is provided with a first arm pivot hole 103 and a protrusion clamping position 107, and the second arm 2 is provided with a second arm pivot hole 203 and a spring clamping slot 206. The hinge part 3 comprises a spring 31 and a pivot shaft 32, wherein the spring 31 comprises a middle protrusion 311 of the spring and two spring ends 312; the pivot shaft 32 may be made of a metal material, and the pivot shaft 32 passes through the first arm pivot hole 103, the spring 31 and the second arm pivot hole 203 at the same time, and the middle protrusion 311 of the spring is clamped in the protrusion clamping position 107 at the same time, and the two spring ends 312 are inserted into the spring clamping slot 206, so that in case of keeping a stable clamping position, the first arm 1 and the second arm 2 are fixed together, and can rotate around the pivot shaft 32 at the same time, so as to hold the eyeglasses.

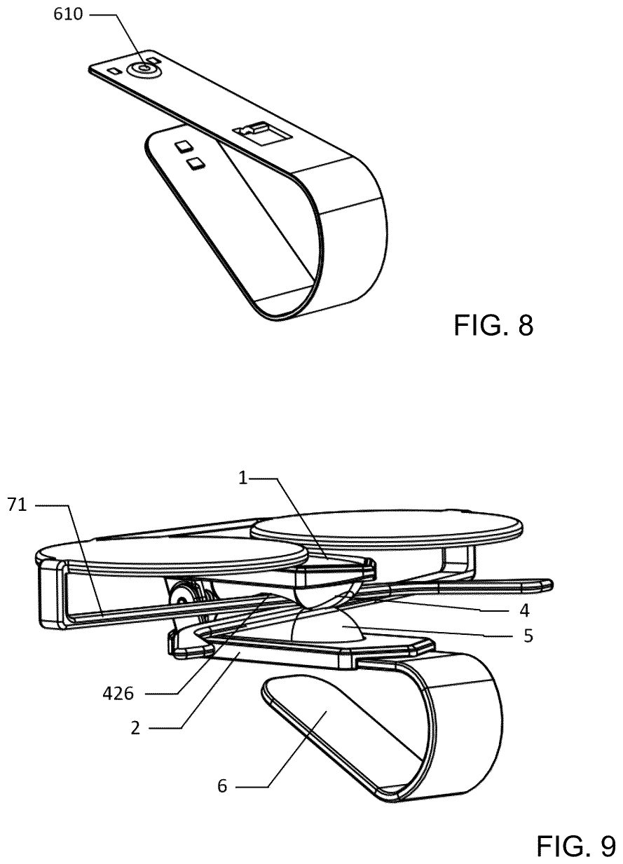

Please refer to FIGS. 4 and 8. The second arm 2 is provided with a second arm mounting hole 210, and the clip 6 is provided with a clip fixing hole 610. The second arm 2 can be fixedly connected to the clip 6 by inserting a screw through the second arm mounting hole 210 and the clip fixing hole 610. It can be understood that the clip 6 may be made of a hard but elastic plastic material or made of manganese steel. Furthermore, the clip 6 may be provided with a protective sleeve. The clip 6 is used to clamp the vehicle-mounted eyeglasses holder to the vehicle body, for example, the position of a sun visor on the vehicle body.

It can be understood that the clip 6 may also be fixedly connected to the first arm 1 in the same way; accordingly, it is only required that the first arm is provided with a corresponding clip fixing hole. There is no particular restriction on the fixing method for the clip herein.

Method of use: after the vehicle-mounted eyeglasses holder is fixed to a target position, e.g., the position of a sun visor, the eyeglasses are pushed into the clamping space by means of the outer guide inclined surface; in the pushing process, the eyeglass legs are squeezed and the vehicle-mounted eyeglasses holder is opened, and the spring ends rotate and the spring is compressed to store elastic potential energy; after the eyeglasses enter the clamping space, the spring releases the elastic potential energy to tightly clamp the eyeglasses; thus, the vehicle-mounted eyeglasses holder can adapt to eyeglasses and other objects of different shapes and sizes. When taking out the eyeglasses, the eyeglasses can be taken out under combined action of the inner guide inclined surface and the solid portion; in that process, the spring is also compressed to store elastic potential energy; after the eyeglasses are taken out, the spring releases the elastic potential energy and the vehicle-mounted eyeglasses holder is closed again.

Finally, it should be noted: the above-mentioned examples are only specific embodiments of the present application, and are used to explain the technical solution of the present application, but are not intended to limit the present application, The scope of protection of the present application is not limited to those examples. While the present application has been described in detail with reference to the above examples, those having ordinary skills in the art can understand that any person skilled in the art can still make modifications or variations to the technical solution described in the above examples easily, or make equivalent replacements to some technical features therein within the technical scope disclosed in the present application; however, such modifications, variations or replacements do not make the essence of corresponding technical solutions deviate from the spirit and scope of the technical solution in the examples of the present application, and should be deemed as falling in the scope of protection of the present application. Therefore, the scope of protection of the present disclosure shall be only confined by the claims.

1. A vehicle-mounted eyeglasses holder, comprising a first arm, a second arm, a hinge part, a first elastic cushion and a second elastic cushion, the first arm and the second arm being connected via the hinge part, the first elastic cushion being fixedly connected to the first arm, the second elastic cushion being fixedly connected to the second arm, and the first elastic cushion abutting against the second elastic cushion, characterized in that,
the first elastic cushion comprises a solid portion, an extension portion and a tail portion, which enclose to form a cavity; the extension portion and the second elastic cushion form a clamping space at a corresponding position, and the extension portion will be squeezed to deform when eyeglasses slide into the clamping space; the solid portion is arranged at an open end of the vehicle-mounted eyeglasses holder, and comprises an outer guide inclined surface for guiding the eyeglasses to slide into the clamping space, and the outer guide inclined surface extends to form the extension portion.

2. The vehicle-mounted eyeglasses holder according to claim 1, characterized in that, the first elastic cushion and the second elastic cushion abut against each other at least at the position of the solid portion.

3. The vehicle-mounted eyeglasses holder according to claim 1, characterized in that, the first elastic cushion and the second elastic cushion abut against each other at the position of the extension portion.

4. The vehicle-mounted eyeglasses holder according to claim 1, characterized in that, an inner guide inclined surface is formed at a position where the solid portion is connected with the cavity.

5. The vehicle-mounted eyeglasses holder according to claim 4, characterized in that, the solid portion is arranged in a generally arch shape by means of the outer guide inclined surface and the inner guide inclined surface.

6. The vehicle-mounted eyeglasses holder according to claim 1, characterized in that, the extension portion is configured generally as a plane.

7. The vehicle-mounted eyeglasses holder according to claim 1, characterized in that, the structure of the second elastic cushion and the structure of the first elastic cushion are arranged in mirror.

8. The vehicle-mounted eyeglasses holder according to claim 1, characterized in that, the first elastic cushion and/or the second elastic cushion are silicone cushions.

9. The vehicle-mounted eyeglasses holder according to claim 8, further comprising a fixing piece, via which the first elastic cushion is connected to the first arm and/or the second elastic cushion is fixedly connected to the second arm.

10. The vehicle-mounted eyeglasses holder according to claim 1, further comprising a clip fixedly connected to the first arm or the second arm.
